(19) United States
(12) Patent Application Publication
(10) Pub. No.: US 2006/0271386 A1
(43) Pub. Date: Nov. 30, 2006

(54) Methods and apparatus for locating devices

(76) Inventor: Kenneth S. Bhella, Stony Brook, NY (US)

Correspondence Address: FAY KAPLUN & MARCIN, LLP, 15O BROADWAY, SUITE 702, NEW YORK, NY, 10038, US

(21) Appl. No.: 11/142,689

(22) Filed: May 31, 2005

(51) Int. Cl. G06Q 99/00

(52) U.S. Cl. 705/1

(57) ABSTRACT

Assets, such as, for example, scanners, can be managed through an asset management network. In one exemplary function, the asset can receive a signal to enter a locate mode. In a locate mode, the asset or a peripheral attached to the asset can make perceptible cues to identify itself. The location mode can be used to pinpoint assets in a large area, identify assets that successfully or fail to complete a process, etc.

### FIELD OF THE INVENTION

The invention is directed to the locating devices, more particularly to methods and apparatus for locating devices coupled to an asset management network.

### BACKGROUND OF THE INVENTION

There are numerous standards for encoding numeric and other information in visual form, such as the Universal Product Codes (UPC) and/or European Article Numbers (EAN). These numeric codes allow businesses to identify products and manufactures, maintain vast inventories, manage a wide variety of objects under a similar system and the like. The UPC and/or EAN of the product is printed, labeled, etched, or otherwise attached to the product as a dataform.

Dataforms are any indicia that encode numeric and other information in visual form. For example, dataforms can be barcodes, two dimensional codes, marks on the object, labels, signatures, signs etc. Barcodes are comprised of a series of light and dark rectangular areas of different widths. The light and dark areas can be arranged to represent the numbers of a UPC. Additionally, dataforms are not limited to products. They can be used to identify important objects, places, etc. Dataforms can also be other objects such as a trademarked image, a person's face, etc.

Objects can also be identified by radio frequency identification (RFID) tags. One type of tag uses the RF field generated by a reader to transmit information to the user through backscatter. That is, the tag reflects radio waves back to a reader, after the waves are modulated to represent information.

Companies use scanners, terminals, mobile computers and other devices to manage inventories, check out and assist customers and for many other tasks. When a company owns and uses a large number of devices, it becomes difficult to manage all of them. For example, locating malfunctioning devices and/or upgrading devices, operating systems, applications, etc., becomes more expensive and time consuming as the number of devices increases. Therefore, asset management networks can be used to simplify the task of managing devices. Devices are coupled to the network through a wire or wirelessly. Processes, such as, installing firmware or software, can be completed quickly and efficiently through the network instead of individually servicing each device.

While an asset management application can identify specific devices on a network comprising a plurality of devices, it can be difficult for a device operator/manger to physically locate the specific device. For example, devices can be scattered throughout a large warehouse, or many similar looking devices may be gathered in a single area and a device operator/manager may have to locate a particular device that failed a software upgrade.

Accordingly, there is a desire for methods and apparatus for physically locating assets, such as, for example, devices coupled to an assent management network.

### SUMMARY OF THE INVENTION

The invention as described and claimed herein satisfies this and other needs, which will be apparent from the teachings herein. An embodiment of the invention includes methods and apparatus for locating devices.

An exemplary method of managing assets comprises placing assets in a locate mode to assist in physically locating the asset. Assets can be, in alternate embodiments, a mobile computer, a kiosk, any PC architecture based device, etc. In an exemplary embodiment of the invention, an asset or a group of assets, for example, a device, receives a signal from a host, for example an asset management computer, to enter a locate mode. The asset then produces a perceptible cue so that an asset operator/manager can easily locate the asset. The asset terminates a locate mode in response to a predetermined amount of time, a predetermined number of iterations of said perceptible cue, a signal for termination, etc. The signal for termination can come from a host coupled to the network and/or a locally manually entered signal. In other embodiments the locate mode is terminated as part of an asset reboot.

Assets can be divided into groups based on their type, their upgrade date, their user or users, a software parameter, an attribute, a range of serial numbers, a range of any attribute, etc.

In an embodiment, the assets can be scanners that comprise a dataform capture module. The dataform capture module can be laser based or image based, and the dataform capture module can be part of another asset, such as, for example, a mobile computer. The complexity of the scanners can range from a dedicated handheld scanner to a sophisticated computer.

The perceptible cues can comprise a solid screen, a screen with text, a flashing screen, a tone, a vibration, a flashing/solid light, a flashing/solid LED and an execution of a normal function, such as, for example, turning on an illumination or targeting module. The perceptible cue can operate on top of a currently running application, for example, a locate screen can be overlaid over a the application's screen. In some embodiments, the intensity of the perceptible cue increases after a predetermined amount of time and/or a predetermined number of iterations of the cue.

When an asset operator/manger wants to execute a process on the assets. He or she can physically track which assets failed or completed the process using the locate mode. An exemplary process is an upgrade method. In this exemplary upgrade mode, assets are placed in a locate mode before an asset upgrade is attempted. Assets remaining in locate mode after a predetermined amount of time have most likely failed the upgrade process. Since the failed assets are exhibiting perceptible cues, an asset operator/manager can easily physically locate them. In an alternate embodiment, assets are placed in a locate mode after a failed process is detected or assumed.

The assets are coupled to an asset management network, which can be a dedicated network or part of a general network. In an embodiment, an asset management computer running a management application can manage the coupled devices. A device location method and a process completion status method can be initiated from the management application.

Other objects and features of the invention will become apparent from the following detailed description, considering in conjunction with the accompanying drawing figures. It is understood however, that the drawings are designed solely for the purpose of illustration and not as a definition of the limits of the invention.

### BRIEF DESCRIPTION OF THE DRAWING FIGURES

The drawing figures are not to scale, are merely illustrative, and like reference numerals depict like elements throughout the several views.

FIG. 1 illustrates and exemplary asset management network implemented according to an embodiment of the invention.

FIG. 2 illustrates and exemplary asset management computer implemented according to an embodiment of the invention.

FIG. 3 illustrates and exemplary device implemented according to an embodiment of the invention.

FIG. 4 illustrates an exemplary asset management computer side device location method implemented according to an embodiment of the invention.

FIG. 5 illustrates an exemplary device side location method implemented according to an embodiment of the invention.

FIG. 6 illustrates an exemplary asset management computer side process completion status method implemented according to an embodiment of the invention.

FIG. 7 illustrates an exemplary device side process completion status method implemented according to an embodiment of the invention.

FIG. 8 illustrates an alternate asset management computer side process completion status method implemented according to an embodiment of the invention.

FIG. 9 illustrates an alternate device side process completion status method implemented according to an embodiment of the invention.

### DETAILED DESCRIPTION OF EXEMPLARY EMBODIMENTS

There will now be shown and described in connection with the attached drawing figures several exemplary embodiments of methods and apparatus for charging a power source.

An asset management computer, for example, using an management application, can maintain a list of assets. Individual assets or groups of assets can be selected and managed through the list, but it can be difficult to physically locate the selected asset or group of assets. Therefore, a location mode that uses perceptible cues, such as, for example, an audio sound, on the asset or group of assets can help an asset operator/manger locate the selected assets. In addition, when an asset operator/manger wants to execute a process on the assets, such as, for example, an upgrade process, the assets that failed or completed the process can be placed in a locate mode so they can be physically identified.

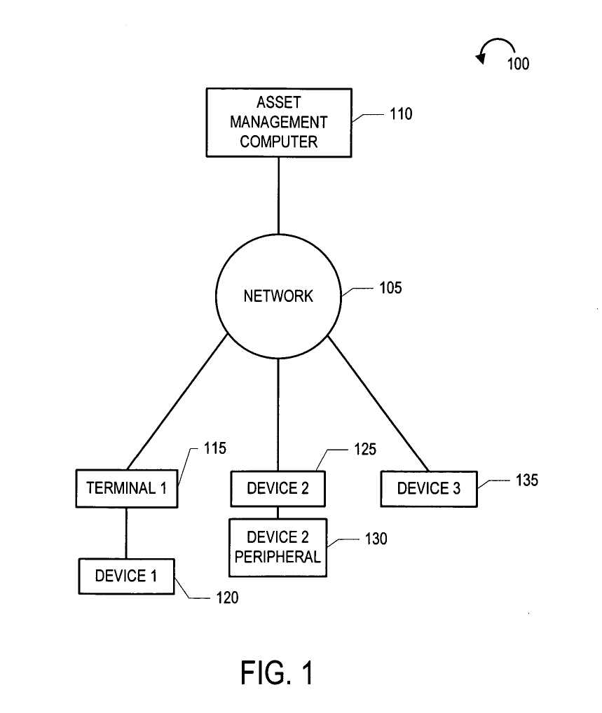

FIG. 1 illustrates an exemplary asset management network 100. Asset management network 100 comprises a network 105. Network 105 can be an internet, an intranet, the Internet, and any other communication network or combination of networks. Additionally, an asset management network 100 can use a part of the network 105, such as, for example a subnet. Therefore, the asset management network 100 can comprise a dedicated and proprietary network 105, or the asset management network 100 can operate over an existing network 105, such as, the Internet. In other embodiments the asset management network 100 is made of a combination of private, public and general networks.

One exemplary type of asset that can be managed by an asset management application is a device. In asset management network 100, device one 120, for example, a scanner, is coupled to a terminal 115, for example a point of sale (POS) terminal. The terminal 115 is coupled to the network 105. Device 2 125 is directly coupled to the network 125 and comprises an attached peripheral 130. Device 3 135 is directly coupled to the network 105. Although, three devices 120, 125, 135 are shown in FIG. 1, in alternate embodiments of the invention, a plurality of devices, terminals, peripherals, etc, can be coupled to the network 105. In addition, while asset management network 100 comprises a plurality of different types of devices and connections to the network 105, in alternate embodiments, the asset management network 100 manages a plurality of similar devices. Additionally, asset management network 100 can also track other physical assets, such as, for example, products, personnel, etc.

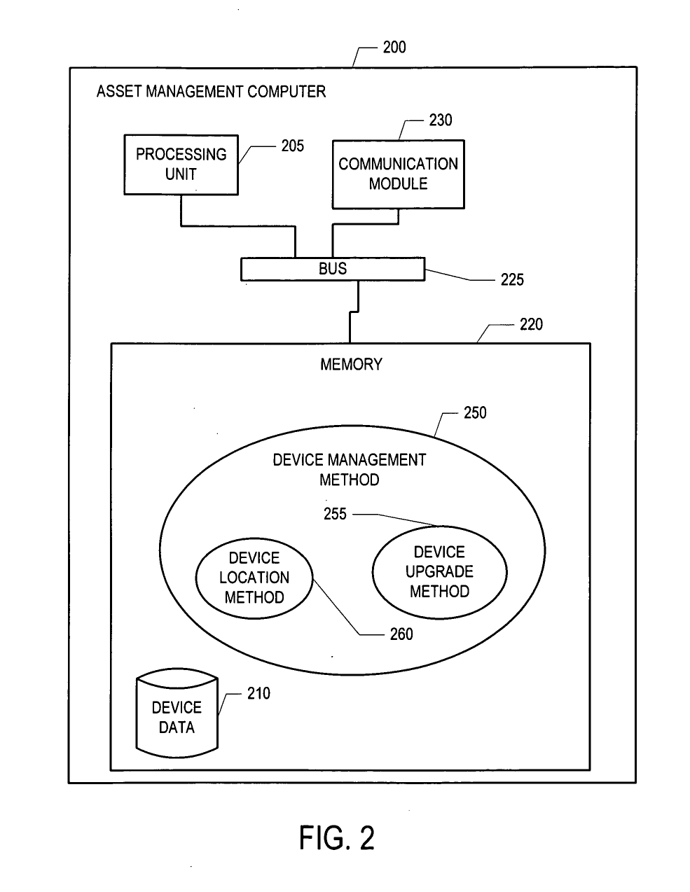

An asset management computer 110 is also coupled to the network 105. Asset management computer 110 comprises methods that are used to manage the assets in the asset management network 100. FIG. 2 illustrates an exemplary asset management computer 200 that can be implemented in one exemplary embodiment as the asset management computer 110 in FIG. 1.

The nodes in asset management network 100 can be coupled together through wires or wirelessly. In addition while asset management network 100 appears to have a client/server configuration, in alternate embodiments of the invention the asset management network 100 can be configured as a peer to peer network. For example, certain, more powerful devices, such as, for example, a mobile computer, can act as “super peers” to simpler devices, such as for example, a handheld scanner.

FIG. 2 illustrates an exemplary asset management computer 200 implemented in accordance with the invention. The computer 200 can be, in exemplary embodiments, a mobile computer, a server, a desktop, etc. The computer 200 comprises a processing unit 205, a communication module 230 and memory 220 coupled together by bus 225. The modules of device 200 can be implemented as any combination of software, hardware, hardware emulating software, and reprogrammable hardware. The bus 225 is an exemplary bus showing the interoperability of the different modules of the asset management computer 200. As a matter of design choice there may be more than one bus, and in some embodiments certain modules may be directly coupled instead of coupled to a bus 225. Additionally, some modules may be combined with others.

Processing unit 205 can be implemented as, in exemplary embodiments, one or more Central Processing Units (CPU), Field-Programmable Gate Arrays (FPGA), etc. In an embodiment, the processing unit 205 can comprise a general purpose CPU. In other embodiments, modules of the processing unit 205 may be preprogrammed or hardwired, in the processing unit's 205 memory, to perform specific functions. In alternate embodiments, one or more modules of processing unit 205 can be implemented as an FPGA that can be loaded with different processes, for example, from memory 220, and perform a plurality of functions. Processing unit 205 can comprise any combination of the processors described above.

Communication module 230 comprises one or more input/output interfaces used by the computer 200 to communicate with users, other devices, etc. Interfaces can include a modem, a network interface card (NIC), a wireless NIC, a monitor, a keyboard, a mouse and any other I/O device.

Memory 220 can be implemented as volatile memory, non-volatile memory and rewriteable memory, such as, for example, Random Access Memory (RAM), Read Only Memory (ROM) and/or flash memory. Memory 220 is illustrated as a single module in FIG. 2, but in some embodiments, memory 220 can comprise more than one memory module and some memory 220 can be part of other modules of the computer 200, such as, for example, processing unit 205.

The memory 220 stores methods, processes and information used to operate the computer 200. Memory 220 comprises device data 210 and device management method 250. Device management method 250 comprises device location method 260 and device upgrade method 255. Device management method 250 can also comprise a plurality of other methods for managing assets in a network.

In an exemplary embodiment of the invention, asset management computer 200 manages a plurality of devices using device management method 250. Device management method 250 is an example of an asset management application. The devices can be, but are not limited to kiosks, scanners, personal digital assistants (PDAs), rugged mobile terminals, signature pads, printers, VCRs, mobile telephones, traditional telephones, pagers, etc. Device management method 250 can maintain information about the managed devices, such as, for example, IP address, serial number, MAC address, model number, current firmware/software versions, battery life, movement. Additionally, device management method 250 can be used to control the network devices. For example, in accordance with embodiments of the invention, a device location method 260 and a device upgrade method 255 can be initiated from the asset management computer 200. In addition, the device management method 250 can also initiate diagnostics and other processes in the device. Information regarding the devices can be stored in memory 220 as devices data 210.

An exemplary device location method 260 assists device managers and/or operators to physically locate the managed devices by initiating perceptible cues in the device or a peripheral attached to the device. When a mobile device, such as, for example, a wireless scanner, is used throughout a large warehouse, the device can get lost, and a device location method can be used to locate the device. In addition, a device location method 260 is also helpful when selecting a specific device amongst a plurality of similar devices.

When using the device location method 260, the asset management computer 200 can select a group of devices. The group may be comprised of particular IP addresses, serial numbers, a location, a product family, a product grouping, date of manufacture, etc. A group can also be comprised of two or more similar characteristics and/or a range of characteristics.

Device upgrade method 255 can also use device location method 260. As will be described further, an exemplary device upgrade method 255, can place a device or a group of devices to be upgraded in a location mode before initiating an upgrade process. Devices that successfully complete the upgrade end the location mode, and devices that failed the upgrade remain in location made. An asset manager can then easily identify the failed devices. An upgrade method is one exemplary process that can use the location mode. In alternate embodiments, the locate mode can be used to identify any successful or failed process in an asset. Alternate upgrade methods will be described below.

The exemplary embodiment of FIG. 2 illustrates device location method 260 and device upgrade method 255 as part of device management method 250, but these methods are not limited to this configuration. Each method and database, described herein, in whole or in part can be separate components or can interoperate and share operations. Additionally, although the methods are depicted in the memory 220, in alternate embodiments the methods can be incorporated permanently or dynamically in the memory of processing unit 205.

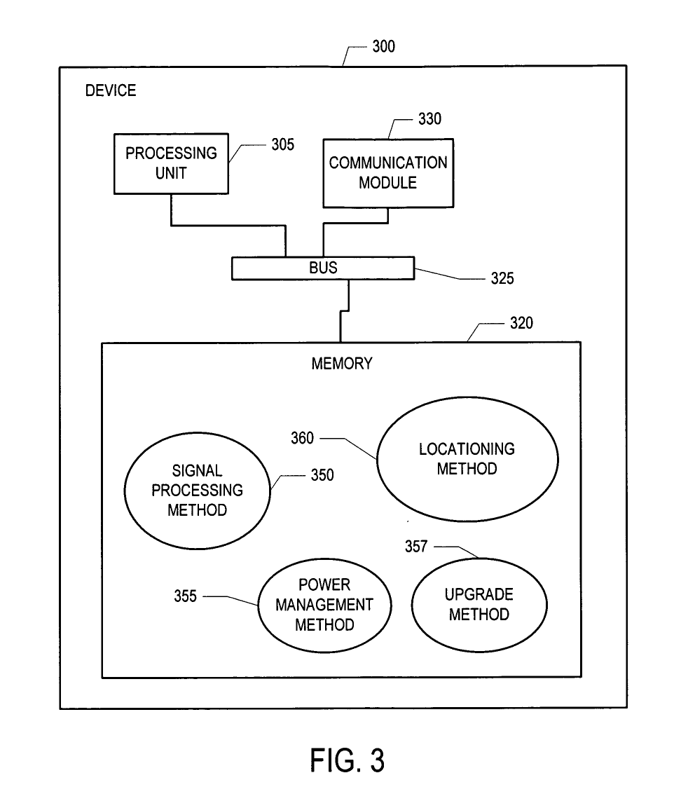

FIG. 3 illustrates an exemplary device 300 implemented in accordance with an embodiment of the invention. The device 300 comprises a processing unit 305, communication module 330 and memory 320 coupled together by bus 325. As with the computer 200, the bus 325 of the device 300 illustrates the interoperability of the modules of device 300. In other embodiments, some modules of the device may be directly coupled together and/or incorporated within one another.

The processing unit 305, the communication module 330 and the memory 320 can be similar to the processing unit, communication module and memory of the computer 200. The memory 320 of device 300 can have stored thereon, a number of methods for operating the device 300.

Different devices perform different functions, thus different devices store different methods in memory. An exemplary device, such as, for example, a handheld scanner, can comprise a signal processing method 350, a locationing method 360, an upgrade method 357 and a power management method 355. In a scanner, when a decoding operation is initiated, for example, a trigger is pressed, the scanner reads a target dataform, for example, a barcode, and analyzes the dataform. Signal processing method 350 is used by the scanner to decode dataforms. The scanner can be a laser scanner, imaging scanner, etc. The decoded signal can be used to obtain information specifically related to a product identified by the dataform. For example, quantity information and price information. This information can be stored on a node in the network 105, for example the asset management computer 110.

Power management method 355 manages the power used by a device 300. In some embodiments, the device 300 can switch to a power save mode, when no activity is detected for a given amount of time. The power save mode can completely shut down the device 300 or alternatively, it can slow down device operations, or initiate other power saving techniques.

In an exemplary embodiment of the invention, when a device 300 receives a signal, for example, an instruction from an asset management computer 200, to enter a location mode, device 300 executes locationing method 360. Locationing method 360 initiates one or more perceptible cues on the device 300 to make the device 300 identifiable to a person. The signal can also come from an instruction in a locally running program, a manually entered command, from another node on the network, etc.

Exemplary perceptible cues include emitting a single or repeating or varied audio sound and/or vibration; a solid and/or flashing screen that can contains information, such as, for example, an IP address, serial number, product grouping and other information; turning on or flashing the illumination and/or aiming pattern generator in a scan engine; turning on or flashing the data acquisition element of a scanner, such as, for example, a laser or light emitting diode (LED); and turning on or flashing a light and/or LED on the device. Any of these perceptible cues can be executed individually, in combination, in series, in parallel, etc.

If another application is running on the device 300 when a location mode signal is received, the device 300 can temporarily override, pause or terminate the running application. For example, a locate mode can override the display on a device and flash information related to the device while the other application is still running in the background. When the locate mode is terminated, the device can resume or restart the previously running application.

When an asset operator/manager wishes to initiate processes, such as, for example, an upgrade method 357 on the device 300, a device list on an asset management computer can inform them which devices completed the process successfully or not. But it may be difficult to physically identify which device failed or completed the process. Therefore, a device can use a locationing method 360 as part of an upgrade method 357 to identify itself to the operator/manger.

As described above, in one embodiment, the device can enter a locate mode before an upgrade method 357 is executed. If the process is successful, the locate mode is terminated. Any device remaining in locate mode failed the process. In an alternate embodiment, the device 300 enters a locate mode when a process, such as, for example, the upgrade method 357, does not complete successfully. In other alternate embodiments, it is possible to configure the invention so that any device remaining in locate mode successfully completed the process. In addition, the invention can be configured to initiate a locate mode in a device 300 after a successful completion of a process.

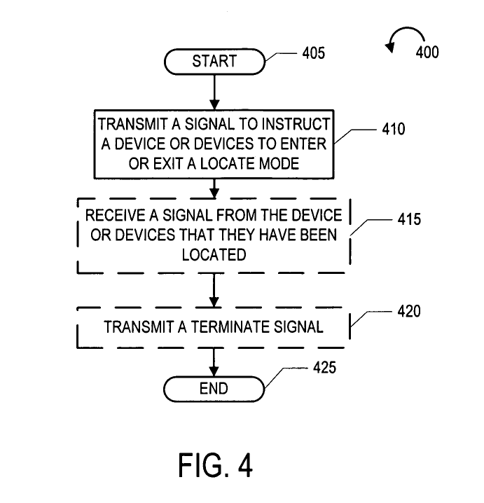

FIG. 4 illustrates an exemplary device location method 400 implemented in accordance with an embodiment of the invention. In embodiments of the invention, the method 400 can be implemented as the device location method 260 of asset management computer 200.

Method 400 starts in step 405, for example, when an asset operator/manger wishes to locate a specific device or group of devices and initiates the method 400, for example, through an asset management application on computer 200. Following step 405, processing proceeds to step 410, where the asset management application transmits a signal to instruct a device or group of devices to enter a locate mode. The signal can be any communication mechanism that informs the device to enter a locate mode, for example, the signal can be a message sent to the device over the network, a signal over a separate network, a signal through a direct connection, etc. In an embodiment of the invention, after step 410, method 400 ends in step 425. Termination of the locate mode is handled at the device.

In an alternate embodiment of the invention, method 400 may perform optional step 415. In step 415, the asset management application receives a signal from the device or devices that they have been located. The signal can be initiated by an operator who found a lost device. The status of the devices coupled to an asset management network may include whether the device is in location mode or not. Therefore, a located device can inform the asset management application that it has been found, so the application can properly update the device's status.

In addition or alternatively, the asset management application can also perform optional step 420. In step 420, the asset management application transmits a terminate signal that takes a device out of a locate mode. This step may be performed in response to receiving a signal that the device has been located or in response to a successfully completed process, for example.

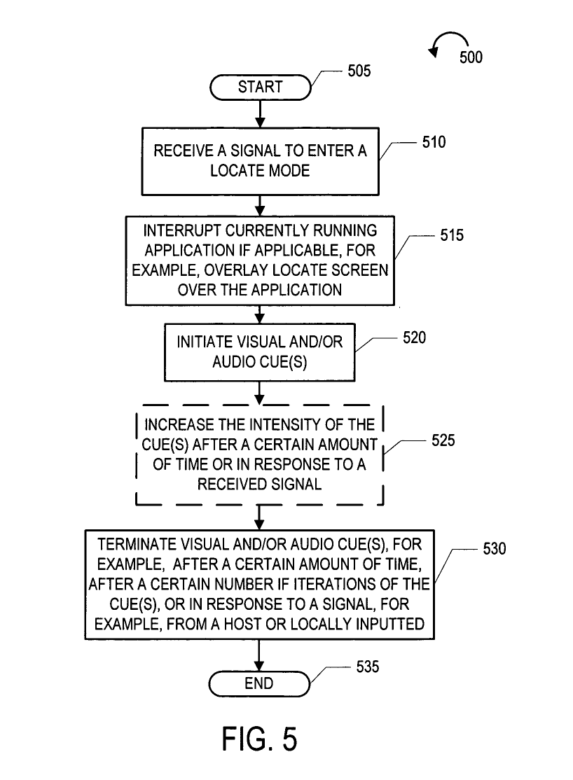

FIG. 5 illustrates an exemplary locationing method 500 implemented in accordance with an embodiment of the invention. In embodiments of the invention, the method 500 can be implemented as the locationing method 360 of device 300.

Method 500 starts in step 505, for example, with the device 300 powering up and connecting to the network 105. In some embodiments, the device 300 connects to an asset management network by connecting directly with an assent management computer 200. In other embodiments, the device connects to an asset management network that is run over a general purpose network, such as, for example, a local area network (LAN). Once coupled to the network 105, the device 300 connects/registers with an application running on, for example, the asset management computer 200 and/or the asset management computer 200 finds the device 300 on the network 105.

Processing proceeds from step 505 to step 510. In step 510, the device 300 receives a signal to enter a locate mode. For example, the device can receive a message from an asset management computer 200 or another device instructing the device to enter a locate mode. Then, processing proceeds to step 515, where if the device 300 is running another application, the device interrupts the application to enter a locate mode. For example, the device can overlay a locate screen over the currently running application's screen. The application may be running in parallel in the background, or the locate mode can pause or terminate any running application.

Following step 515, processing proceeds to step 520, where the device initiates perceptible cues. As mentioned above the perceptible cues can be an audio sound, a display on a screen, etc. In addition, in some embodiments, a peripheral coupled to the device can execute the perceptible cue, or if the device is coupled to a terminal, the terminal can execute the cue.

Following step 515, processing can optionally proceed to step 525. In step 525, the device 300 increases the intensity of the perceptible cue or cues after a certain amount of time and/or a certain number of iterations of the cue. Additionally, the intensity of the cues can be increased from the asset management computer 200, or another node.

In step 530, the device 300 terminates the perceptible cue or cues. The device 300 can terminate a locate mode in response to a signal received from a node on the network or from a signal generated locally. In addition, the device 300 can terminate the locate mode after a certain amount of time, after a certain amount of iterations of the cue, after dropping below a certain battery level, etc. Following step 530, processing of method 500 ends in step 535, for example, with the device 300 returning to a previously running application.

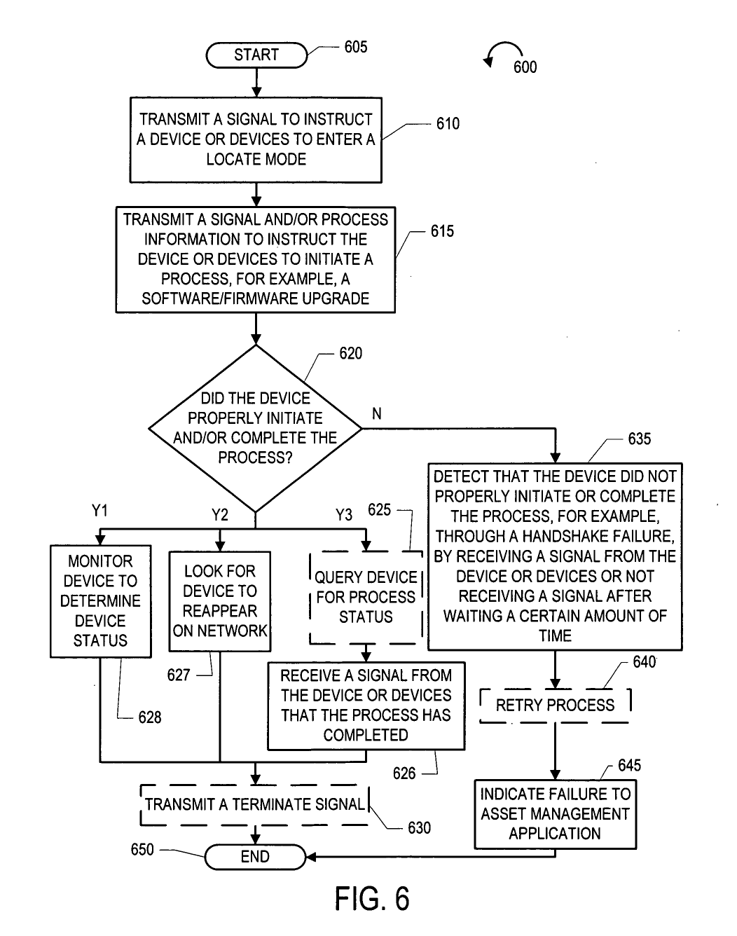

FIG. 6 illustrates an exemplary process completion status method 600 implemented in accordance with an embodiment of the invention. In embodiments of the invention, the method 600 can be implemented as the device upgrade method 255 of asset management computer 200.

Method 600 starts in step 605, for example, when an asset management application initiates a process on one or more managed devices. An exemplary process can be upgrading device software and/or firmware. Processing proceeds to step 610 where an asset management application, such as for example, device upgrade method 255, transmits a signal to instruct a device or devices to enter a locate mode. Following this step, if any device does not enter a locate mode, then a device operator/manger can quickly determine that those devices will fail the upcoming process.

Following step 610, processing proceeds to step 615, where the device upgrade method 255 transmits a signal and/or process information to instruct a device or devices to initiate a process, for example a software and/or firmware upgrade. Process information can be the software/firmware upgrade itself, an instruction to start downloading the software/firmware upgrade, an instruction to begin installation of a previously downloaded upgrade, etc.

In step 620, processing proceeds depending on whether the device properly initiated and/or completed the process. If the device properly completes the process, method 600 proceeds to one or more options indicated as Y1, Y2 and Y3. In various embodiments, the device upgrade method 255 can implement one, two, three or any combination of these options.

Following path Y1, processing proceeds from step 620 to step 628, where the device upgrade method 255 monitors the device or devices to determine the status of the device. The devices can maintain status information that includes current firmware and/or software versions. Or in alternate embodiments the information can be an upgrade flag in the devices' registry. In step 628, the device upgrade method 255 can read or download the device status information to determine whether the latest upgrade was successfully installed. Then processing proceeds to optional step 630.

Following path Y2, processing proceeds to step 627. In step 627, the device upgrade method 255 monitors the network to look for upgraded devices to reappear on the network. In one exemplary embodiment of the invention, an upgraded device reboots after a successful upgrade. During a rebooting process the device disconnects from the network and reappears on the network. Thus, a device upgrade method 255 can identify successfully upgraded devices by waiting for them to reappear on the network.

Following path Y3, processing proceeds optionally to step 625. In this optional step the device upgrade method 255 queries upgrading devices for their status. In some embodiments, the device upgrade method 255 can wait for process completion signals from devices and in other embodiments, the device upgrade method 255 can query the devices for their status. In step 626, the device upgrade method 255 receives a signal from the device or devices indicating that the upgrade process has completed successfully. Then processing proceeds to optional step 630.

The device upgrade method 255 can also be configured (not shown) to assume an upgrade is successful if no failure signal is received from a device after waiting a certain amount of time.

In optional step 630, the device upgrade method 255 can transmit a signal that terminates a locate mode in a device. This step is optional because in some embodiments, termination of the locate mode occurs in reboot, or a locate mode is terminated by a local operation following a successful process completion. Following step 630, method 600 ends in step 650.

Returning to step 620, when a device does not properly initiate and/or complete a process, method 600 proceeds to step 635. In step 635, the device upgrade method 255 detects that a device or devices did not successfully initiate or complete a process, for example, through a handshake failure, by receiving a signal from the device or devices and/or through not receiving a signal after waiting a certain amount of time.

An upgrade process and any other process can fail at many points. For example, the connection between the device and the network or the connection between the asset management computer and the network might fail as upgrade information is being transmitted, or the upgrade information may have been corrupted in transit, or the upgrading process may encounter unexpected complications at the device and not complete successfully.

In an embodiment, when a network connection failure occurs the device and the asset management computer 200 fail a handshake process. For example, the asset management computer 200 sends out a handshake request signal, but does not receive a response. If the network connection failure occurs at the asset management computer 200 while process information is being transmitted, the computer 200 can assume that the process has failed at the device.

If an error occurred at the device and the connection between the device and the asset management computer 200 is still active, then in an embodiment of the invention, the device can send a signal to the asset management computer 200, informing the computer 200 that the process failed.

Following step 635, processing proceeds to optional step 640. In optional step 640, the asset management computer 200 and the device 300 retry the process. This step can be repeated a predetermined amount of time or until the process is successfully completed.

Following step 640, processing proceeds to step 645, where the failure of the process is indicated at the asset management application, for example, a failed upgrade attempt is indicated on the device management method 250 running on asset management computer 200. Since the locate mode was initiated on the device before the upgrade was attempted, if a network connection failure occurs during the transmission of the upgrade information, the device is still easily identifiable by a device operator/manager. Then, method 600 ends in step 650. If the upgrade method 255 ends in a failure, a device operator/manger can attempt to manually upgrade the device or attempt to determine and solve the problem with the upgrade.

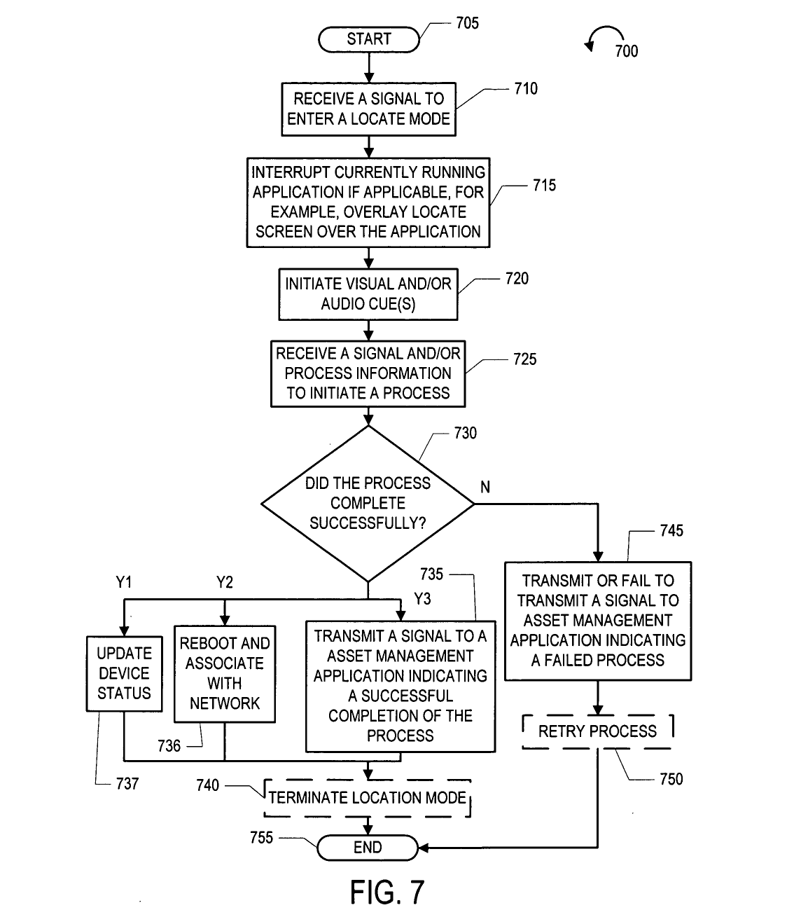

FIG. 7 illustrates an exemplary process completion method 700 implemented in accordance with an embodiment of the invention. In embodiments of the invention, the method 700 can be implemented as the upgrade method 357 of device 300.

Method 700 starts in step 705 and proceeds to step 710. In step 710, the device 300 receives a signal to enter a locate mode. Then, in step 715, if the device is currently running an application, the device 300 interrupts the application to enter a locate mode. An exemplary locate mode overlays a locate screen over a running application. Following step 715, processing proceeds to step 720, where the device 300 initiates perceptible cues. Then, in step 725, the device receives a signal and/or process information to initiate a process, for example an upgrade process.

In step 730, the device determines whether the process was completed successfully. As with the previous method 600, method 700 has at least three options after a successful process completion. Following path Y1, processing proceeds to step 737 where the device updates its status. For example the device can update an upgrade flag or a software/firmware version. An asset management application can then peer into the device and determine, from its status, whether the process was successfully completed. Then, processing proceed to optional step 740.

Following path Y2, after a successful process completion, the device reboots and associates with the network. This re-association is a sign to an asset management application that the process is successfully completed.

Following path Y3, the device transmits a signal to an asset management application indicating that the process was completed successfully. In an embodiment, the signal can be a message comprising the current software/firmware versions of the device. Processing proceed to optional step 740.

Also, in some embodiments the device can do nothing after a successful completion of a process and proceed directly to end step 755. In this embodiment, the asset management application is configured to assume a successful completion if no failure notice is received. In various embodiments of the intention, the device can perform all, some, or one of these options in response to a successful process completion.

In optional step 740, the device terminates the locate mode. The locate mode can be terminated in response to a manually entered signal and/or in response to a command from an asset management application. This step is optional because the termination if the locate mode can be part of a reboot step.

Returning to step 730, if the device determines that the process did not complete successfully, processing proceeds to step 745. In step 745, the device transmits a signal to an asset management application indicating a failed process. As mentioned earlier the signal can be part of a network connection integrity request, such as, for example, a handshake request. In an alternate embodiment, the asset management application can assume that the device failed the process if the device fails to send a message to the application within a certain amount of time.

Following step 745, processing proceeds to optional step 750. In optional step 750, the device retries the process a number of times. If the process continues to fail, method 700 ends in step 755. Since the device was placed in a location mode before the process was executed, the device is easily identifiable by a device operator/manager.

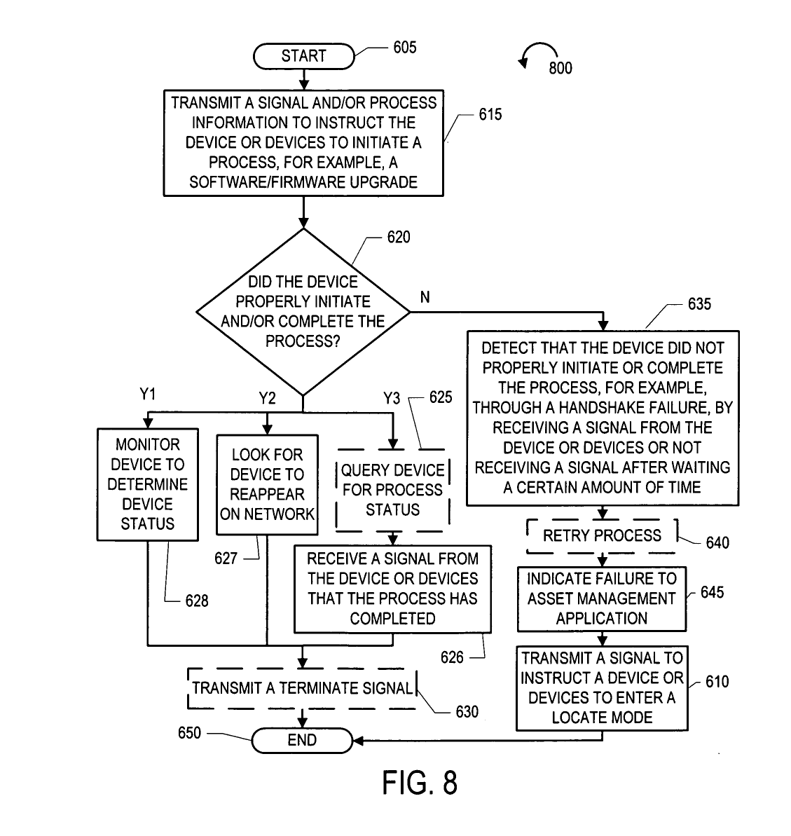

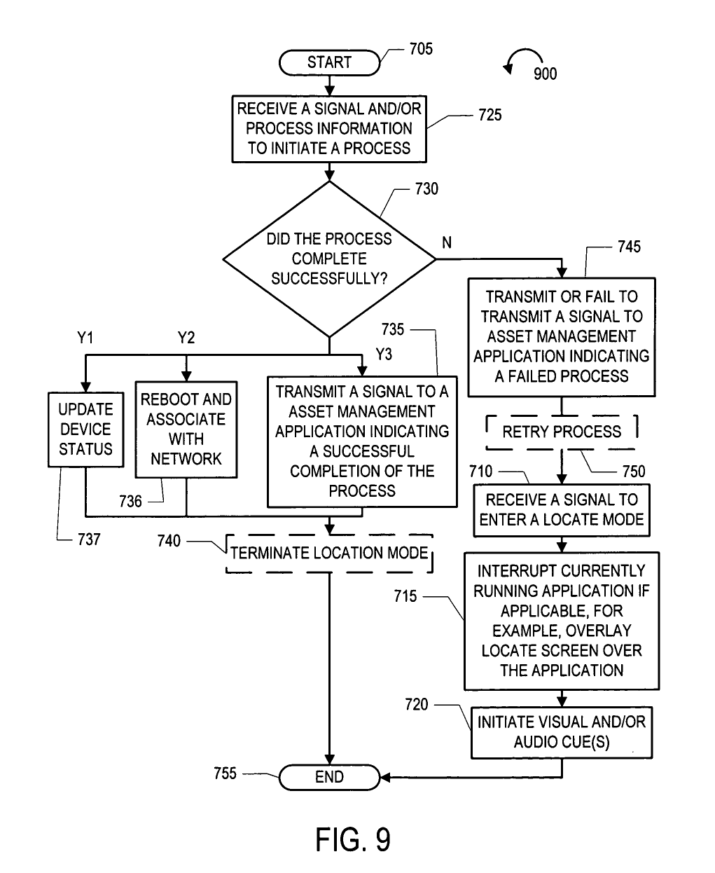

The order of the steps of the methods described herein are exemplary and the order of the steps may be rearranged. In addition, some steps may be omitted and/or other steps added in alternate embodiments of the invention. FIGS. 8 and 9 illustrate an examples of alternately arranged steps. Similarly numbered steps perform similar functions.

FIG. 8 illustrates an alternate asset management computer side process completion status method 800, where the locate mode is initiated after a process fails to complete successfully. Therefore, step 610 occurs after step 645. FIG. 9 illustrates an alternate device side process completion status method 900. In method 900, steps 710, 715 and 720 occur after step 750. In some embodiments, the signal to enter a locate mode comes from the network, and in other embodiments the signal is received locally. For example, when a device detects a network connection problem, the device can put itself in locate mode so that a device operator/manger is notified that there is a problem.

While there have been shown and described and pointed out fundamental novel features of the invention as applied to preferred embodiments thereof, it will be understood that various omissions and substitutions and changes in the form and detail of the disclosed invention may be made by those skilled in the art without departing from the spirit of the invention. It is the intention, therefore, to be limited only as indicated by the scope of the claims appended hereto.

What is claimed:

1. A method of asset management comprising:
receiving a signal, from a host coupled to an asset management network;
producing a perceptible cue; and
terminating said perceptible cue.

2. The method of claim 1, wherein an asset comprises a dataform capture module.

3. The method of claim 1, wherein said perceptible cue can comprise at least one of a solid screen, a flashing screen, a tone, a vibration, a flashing light emitting diode and an execution of a normal function.

4. The method of claim 1, further comprising receiving a locate mode signal by a group of assets.

5. The method of claim 4, wherein said group is comprised of assets of at least one of a type, an upgrade date, a similar user, a software parameter, an attribute, a range of serial numbers and a range of any attribute.

6. The method of claim 1, further comprising overlaying a locate screen over an application that is currently running.

7. The method of claim 1, further comprising increasing an intensity of said perceptible cue after at least one of a predetermined amount of time and a predetermined number of iterations of said perceptible cue.

8. The method of claim 1, further comprising receiving said signal for termination from one of a host coupled to said network and a locally manually entered signal.

9. The method of claim 1, wherein said signal for termination is a reboot signal.

10. A method of asset management comprising:
receiving a signal, from a host coupled to an asset management network;
producing a perceptible cue; and
obtaining process information.

11. The method of claim 10, further comprising updating a status of said at least one asset.

12. The method of claim 10, wherein said process information comprises an instruction to execute a process.

13. The method of claim 10, wherein said process information comprises an upgrade for said at least one asset.

14. The method of claim 10, further comprising terminating said locate mode after a successful completion of a process.

15. The method of claim 10, further comprising rebooting and associating with said asset management network.

16. The method of claim 10, further comprising transmitting a signal to a host coupled to said network indicating the status of a process.

17. The method of claim 16, wherein said step of transmitting a signal to a host coupled to said network indicating the status of a process, comprises transmitting a connection integrity request.

18. A method of asset management comprising:
transmitting a signal, to at least one asset coupled to an asset management network, wherein said signal produces a perceptible cue in said asset; and
transmitting process information.

19. The method of claim 18, further comprising receiving a signal from said at least one asset coupled to said network indicating the status of a process.

20. The method of claim 18, further comprising monitoring a status of said at least one asset.

21. The method of claim 18, further comprising looking for said at least one asset to reappear on said network.

22. The method of claim 18, further comprising indicating a failed process to a network manager.

23. A method of asset management comprising:
obtaining process information; and
after an execution of a process,
receiving a signal, from one of a host coupled to an asset management network and a locally generated signal, and
producing a perceptible cue.

24. The method of claim 23, wherein said steps of receiving a signal, from one of a host coupled to an asset management network and a locally generated signal, and producing a perceptible cue, is executed in response to a failed completion of a process.

25. The method of claim 23, further comprising transmitting a signal to a host coupled to said network indicating the status of said process.

26. The method of claim 23, further comprising receiving a signal for termination of said locate mode from one of a host coupled to said network and a locally received signal.

27. A device comprising:
a processing unit;
a communication module; and
memory having at least one process stored thereon for,
receiving a signal, from one of a host coupled to an asset management network and a locally generated signal,
producing a perceptible cue, and
terminating said perceptible cue.

28. The device of claim 27, wherein said perceptible cue is produced on a device coupled to said asset.

29. The device of claim 27, wherein said at least one process further comprises obtaining process information.

30. The device of claim 29, wherein said at least one process further comprises transmitting a signal to a host coupled to said network indicating the status of a process.

31. The device of claim 30, wherein said step of initiating a locate mode is executed in response to a failed process.

32. An asset management system comprising:
at least one asset management host;
at least one asset coupled to said asset management host over an asset management network, said asset comprising,
a processing unit;
a communication module; and
memory having at least one process stored thereon for,
receiving a signal, from one of a host coupled to an asset management network and a locally generated signal,
producing a perceptible cue, and
terminating said perceptible cue.

33. The system of claim 32, wherein said at least one asset is coupled wirelessly to said network.

34. The system of claim 32, wherein said at least one process further comprises obtaining process information.

35. The system of claim 34, wherein said at least one process further comprises transmitting a signal to a host coupled to said network indicating the status of a process.

36. The system of claim 35, wherein said step of initiating a locate mode is executed in response to a failed process.
